(19) United States
(12) Patent Application Publication
(10) Pub. No.: US 2026/0222942 A1
(43) Pub. Date: Jul. 30, 2026

(54) UPLINK TRANSMISSION SWITCHING WITH ASSOCIATED BANDS

(71) Applicant: Apple Inc., Cupertino, CA (US)

(72) Inventors: Ankit Bhamri, Haar, Bavaria (DE); Oghenekome Oteri, San Diego, CA (US); Sigen Ye, Whitehouse Station, NJ (US); Haitong Sun, Cupertino, CA (US); Wei Zeng, Saratoga, CA (US); Yang Tang, San Jose, CA (US); Dawei Zhang, Saratoga, CA (US); Huaning Niu, San Jose, CA (US)

(21) Appl. No.: 19/147,217

(22) PCT Filed: Dec. 11, 2023
(86) PCT No.: PCT/US2023/083446

§ 371 Date: Jul. 10, 2025

Related U.S. Application Data
(60) Provisional application No. 63/438,399, filed on Jan. 11, 2023.

(51) Int. Cl. H04W 36/06; H04W 72/232

(52) U.S. Cl. CPC H04W 36/06; H04W 72/232

(57) ABSTRACT

A user equipment (UE) includes a set of transceivers and a processor. In some examples, the UE may receive an uplink (UL) switching indication that indicates UL transmission switching on one antenna port. In some examples, the UE may transmit a first UE capability. The first UE capability may indicate support to switch a transmit chain to an associated band. In some examples, the UE may transmit a second UE capability. The second UE capability may indicate support to transmit on an unchanged transmit chain during an UL switching period for a switching transmit chain. The UE may also be triggered for a first UL transmission switch from one of a first band on a first transmit chain or a second band on a second transmit chain to a third band. Additionally, the UE may switch the first band or the second band to the third band.

### CROSS-REFERENCE TO RELATED APPLICATION

This Patent Cooperation Treaty patent application claims priority to U.S. Provisional Patent Application No. 63/438,399, filed Jan. 11, 2023, and titled “Uplink Transmission Switching with Associated Bands,” the contents of which are incorporated herein by reference in its entirety.

### TECHNICAL FIELD

This application relates generally to wireless communication systems, including techniques for uplink (UL) switching with associated bands in wireless communication systems.

### BACKGROUND

Wireless mobile communication technology uses various standards and protocols to transmit data between a network device (e.g., a base station) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device or base station is an Evolved Universal Terrestrial Radio Access Network (E-UTRAN) Node B (also commonly denoted as evolved Node B, enhanced Node B, eNodeB, or eNB). One example of an NG-RAN network device or base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example wireless communications system including an example of a UE and one or more network devices in a 5G or NR network.

FIG. 2 illustrates a first example method of wireless communication by a UE.

FIG. 3 illustrates an example of UL transmission switching for wireless communication between a UE and one or more network devices.

FIGS. 4A and 4B illustrate examples of UL switching gaps for band pairs associated with UL transmission switching.

FIG. 5 illustrates a second example method of wireless communication by a UE.

FIGS. 6A and 6B illustrate examples of UL switching gaps for band pairs associated with UL transmission switching.

FIG. 7 illustrates an example of UL switching gaps for band pairs associated with UL transmission switching.

FIG. 8 illustrates a third example method 800 of wireless communication by a UE.

FIG. 9 illustrates an example of UL transmission switching for wireless communication between a UE and one or more network devices.

FIG. 10 illustrates an example architecture of a wireless communication system, according to embodiments disclosed herein.

FIG. 11 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

In a 3GPP network, for example with respect to NR Release 15, a UE may be triggered to switch from one particular band to another in support of UL transmissions related to carrier aggregation and dual connectivity. Certain UL switching constraints exist that may limit UL coverage for such 3GPP networks as well as create uncertainty with regard to UE behavior when the UE is triggered to switch bands for UL transmission. In accordance with aspects of the present disclosure, enhancements for multi-carrier UL switching operations are described. In some embodiments, an UL transmission switching scheme may involve up to four bands with up to two simultaneous UL transmissions on two transmit chains. In some UL transmission schemes for example, the UE may support dynamic UL transmission switching across multiple configured bands. In some embodiments, additional UE capabilities are introduced such that UE behavior corresponding to various network configurations is unambiguous and enables efficient UL transmission switching between one or more bands. In some implementations, for example, the UE may have a particular transmit chain associated with a certain band, and in some cases, may have both transmit chains being used for UL transmission. That is, for example, a first band may be configured for a first transmit chain of the UE and a second band may be configured for a second transmit chain for the UE. Based on certain network configurations and reported UE capabilities, the UE may determine whether and how to switch one or more of two existing bands to one or more new bands from the multiple bands configured for UE.

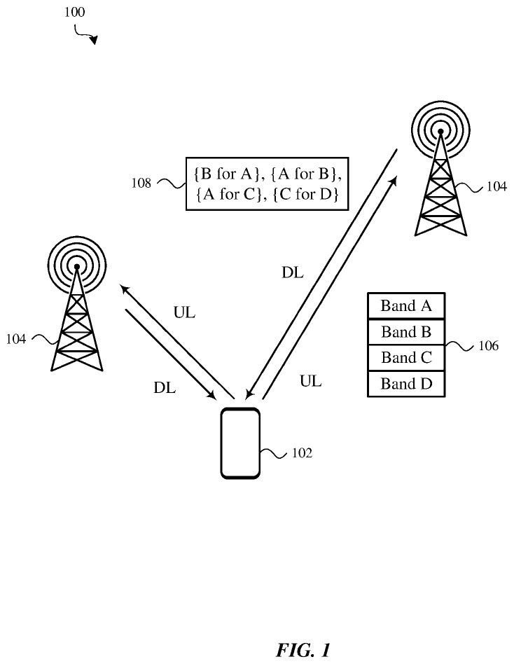

FIG. 1 shows an example wireless communications system 100 in accordance with some embodiments and various aspects of the present disclosure. Wireless communications system 100 may be a 5G or NR network as an example environment in which embodiments described herein may be practiced. In some embodiments, wireless communications system 100 may include a UE 102 and one or more network devices 104 (e.g., a network device of a RAN, such as but not limited to a base station). The UE 102 may communicate with the one or more of the network devices 104 on a DL and an UL. In some embodiments, the UE 102 may communicate with the one or more network devices 104 via UL transmissions using two transmit chains.

In supporting dynamic UL transmission switching, the UE 102 may indicate support for such UL transmission switching in band combination 106. Band combination 106 may include four band entries: Band A, Band B, Band C and Band D. However, various band combinations indicated by the UE 102 may include fewer or more band entries. That is, for example, the UE 102 may compile a list of candidate band combinations including band combination 106. The network device 104 may receive band combination 106 as a request from the UE 102 and confirm availability of these bands for use by the UE 102. In some embodiments, the UE 102 may transmit band combination 106 in a UE capability information element (e.g., BandCombinationList) via radio resource control (RRC) signaling with network device 104.

Network device 104 may send an associated band configuration 108 corresponding to at least some of the band entries in the band combination 106. That is, for example, the associated band configuration 108 may indicate an association in which a transmitting band is paired with an associated band such that when the transmitting band is associated with one of the transmit chains (e.g., the first transmit chain or the second transmit chain), the associated band is to be assigned on another transmit chain on the UE 102. In some embodiments, the network device 104 may send the associated band configuration 108 via RRC signaling. In some embodiments, however, the network device 104 may send the associated band configuration 108 via medium access control (MAC) control element (CE) signaling or other signaling techniques. Additionally or alternatively, the UE 102 may transmit the associated band configuration 108 to the network device 104 (e.g. via RRC signaling) in accordance with some embodiments.

In some embodiments, the associated band configuration 108 may indicate {Band B for Band A}, {Band A for Band B}, {Band A for Band C} and {Band C for Band D}. That is, for example, the first entry {Band B for Band A} of the associated band configuration 108 means that Band B is the associated band for Band A (e.g., when Band A is transmitting or scheduled for transmission on one of the transmit chains of the UE 102). Similarly, the second entry {Band A for Band B} of the associated band configuration 108 means that Band A is the associated band for Band B, the third entry {Band A for Band C} of the associated band configuration 108 means that Band A is the associated band for Band C, and the fourth entry {Band C for Band D} of the associated band configuration 108 means that Band C is the associated band for Band D.

The UE 102 may be configured such that a first transmit chain is associated with Band A and a second transmit chain is associated with Band B. Network device 104 may trigger the UE 102 to switch to Band C. For example, the network device 104 may send and the UE 102 may receive a downlink control information (DCI) scheduling an UL transmission on a carrier on Band C. In some embodiments, the UL transmission scheduled by the DCI may involve one antenna port. As such, the UE may assign one transmit chain to support the transmission on the carrier on Band C. Accordingly, the UE 102 may determine whether to switch the first transmit chain associated with Band A to Band C or to switch the second transmit chain associated with Band B to Band C. As described herein, the UE 102 may determine which transmit chain to switch in this UL switching scenario and other scenarios based at least in part on additional UE capabilities reported to the network and/or network configurations related to, for example, associated bands.

For example, based at least in part on the associated band configuration 108, when UE 102 is configured such that the first transmit chain is associated with Band A and the second transmit chain is associated with Band B, and the network device 104 triggers the UE 102 to switch to Band C for a scheduled UL transmission involving one antenna port, the UE 102 may switch the second transmit chain associated with Band B to Band C. That is, for example, because Band A is the associated band for Band C, by switching second transmit chain to Band C, the first transmit chain associated with Band A remains associated with Band A in compliance with the associated band configuration 108, specifically the third entry.

Similarly, for example, based at least in part on the associated band configuration 108, when UE 102 is configured such that the first transmit chain is associated with Band A and the second transmit chain is associated with Band B, and the network device 104 triggers the UE 102 to switch to Band D for a scheduled UL transmission involving one antenna port, the UE 102 may switch one of the first or second transmit chain to Band D and the other of the first or second transmit chain to Band C. That is, for example, because Band C is the associated band for Band D, and neither of the first or second transmit chain is initially associated with Band C, no switching selection between the first or second transmit chain results in the one of the transmit chains being associated with Band C.

Consequently, even though only a single transmit chain switch to Band D is indicated by the DCI, a dual transmit chain switch results in order to comply with the associated band configuration 108, specifically the fourth entry. Configuring the two transmit chains with a pair of bands that are associated may advantageously enable greater scheduling flexibility between the UE 102 and the one or more network devices 104. That is, for example, the associated band, Band C, on the other of the first or second transmit chain may be selected by the network based on that band being complementary to the transmitting band, Band C, for example, with respect to frequency range, available UL resource capacity, etc.

Turning now to additional considerations (e.g., radio frequency-focused considerations relating to potential increases of switching period and switching complexity) for optimizing UL switching operations, it may be preferential in some cases not to switch a transmit chain if that transmit chain is not required to satisfy the UL transmission being triggered. That is, for example, in one of the UL switching scenario discussed above, a different resulting transmit chain configuration of the UE 102 may be preferable. Under such additional considerations, for example, when the UE 102 is configured such that the first transmit chain is associated with Band A and the second transmit chain is associated with Band B, and the network device 104 triggers the UE 102 to switch to Band D for a scheduled UL transmission involving one antenna port, the UE 102 may switch either the first or second transmit chain to Band D and leave the other transmit chain unchanged. That is, for example, because the UL transmission scheduled on Band D involves only one antenna port, only one transmit chain needs to be switched by the UE and one of the two transmit chains will be unchanged due to the UL switch for this trigger UL transmission. The resulting transmit chain configuration of the UE 102, however, would not comply with the associated band configuration 108.

An advantage of keeping one of the two transmit chains unchanged during UL switching operations is that UL transmissions may be performed by the UE 102 on the unchanged transmit chain during the switching gap associated with the transmit chain being switched to the new band. For example, when the network device 104 triggers the UE 102 to switch to Band D for a scheduled UL transmission involving one antenna port as discussed in the scenario above, the UE 102 may switch the first transmit chain associated with Band A to Band D and leave the second transmit chain associated with Band B unchanged to perform an UL transmission (e.g., a configured grant scheduled on a carrier on Band B) during the switching period for the UL switch from Band A to Band D of the first transmit chain.

In some embodiments, each of the first transmit chain and the second chain of UE 102 may include one or more components or circuits to support UL transmission. That is, for example, the one or more components or circuits may be a digital to analog converter (DAC), a radio frequency (RF) mixer or switching circuitry, phase lock loop (PLL) circuitry, a power amplifier (PA), etc. It is to be appreciated that other components and circuits may be included in each of the first transmit chain and the second chain of UE 102, and multiples of the same or similar circuit or component (e.g., multiple PAs) may be included in a particular transmit chain. In some embodiments, the first transmit chain and the second chain of UE 102 may include the same one or more components or circuits. In some embodiments, one transmit chain of the first transmit chain or the second chain of UE 102 may have at least one component or circuit different from the other transmit chain.

Based on various considerations and sometime contradictory or ambiguous configurations for UL switching with associated bands, techniques are further described herein to provide enhanced UL transmission and switching operations. It is to be understood, that any of the Band A, Band B, Band C or Band D may be a radio frequency band supported and provided to be the same or different network devices 104. These bands may be configured in Frequency Range 1 (FR1) and/or Frequency Range 2 (FR2), for example, however other frequency ranges are contemplated for the UL transmission and switching techniques described herein. In some embodiments, these bands on which the UE may perform simultaneous UL transmission using the first transmit chain and the second transmit chain may be time division duplex (TDD) or frequency division duplex (FDD). That is, for example, a first band on the first transmit chain of the UE 102 may be TDD and a second band on the second transmit chain of the UE 102 may be FDD. However, in some embodiments, the first and second bands may both be TDD, or the first and second bands may both be FDD, for example. Additionally, the UE 102 may perform the UL switching techniques with associated band configurations described herein in support of various band combinations and carrier implementations such as, but not limited to, NR carrier aggregation (CA) or multi-RAT dual connectivity (MR-DC) band combinations (e.g., next generation (NG) EUTRA-NR dual connectivity EN-DC, NR dual connectivity (NR-DC), NR-EUTRA dual connectivity (NE-DC), etc.)

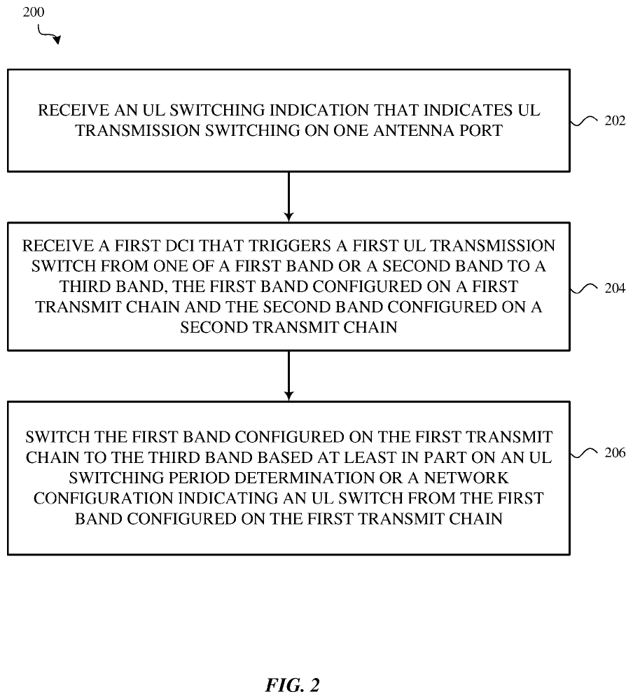

FIG. 2 illustrates an example method 200 of wireless communication by a UE, in accordance with some embodiments and various aspects of the present disclosure. The method 200 may be performed by the UE 102 described with reference to FIG. 1 or by other UEs described herein. The method 200 may be performed using a processor, a set of transceivers (e.g., one or more transceivers) or other components of a UE.

At 202, the method 200 may include receiving an UL switching indication that indicates UL transmission switching on one antenna port.

At 204, the method 200 may include receiving a first DCI that triggers a first UL transmission switch from one of a first band or a second band to a third band. In some embodiments, the first band may be configured on a first transmit chain and the second band may be configured on a second transmit chain.

At 206, the method 200 may include switching the first band configured on the first transmit chain to the third band based at least in part on an UL switching period determination or a network configuration indicating an UL switch from the first band configured on the first transmit chain.

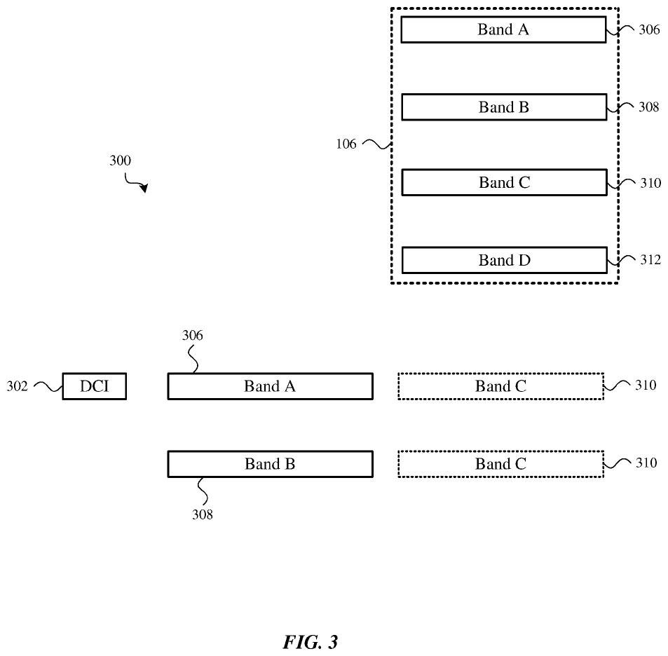

FIG. 3 illustrates an example of UL transmission switching for wireless communication between a UE and one or more network devices. The UL transmission switch may be performed by the UE 102 described with reference to FIG. 1 or by other UEs described herein, and in conjunction or cooperation with the one or more network devices 104 with reference to FIG. 1 or by other network devices described herein. With reference to the example of FIG. 3, various aspects of the method 200 may be illustrated in UL switching scenario 300.

In some embodiments of the method 200, for example, the UE may perform UL transmissions in accordance with band combination 106, which may include a first band 306 (e.g., Band A), a second band 308 (e.g., Band B), a third band 310 (e.g., Band C) and fourth band 312 (e.g., Band D). That is, for example, the UE may utilize one or both of a first transmit chain and a second transmit chain for UL transmissions on one or more carriers in one or more of the first band 306 (e.g., Band A), the second band 308 (e.g., Band B), the third band 310 (e.g., Band C), or the fourth band 312 (e.g., Band D). In UL switching scenario 300, the UE may have an existing UL transmission on the first band 306 (e.g., Band A) configured on the first transmit chain and an existing UL transmission on the second band 308 (e.g., Band B) configured on the second transmit chain.

In some embodiments of the method 200, for example, the UE may receive an UL switching indication that indicates UL transmission switching on one antenna port. In some embodiments, the UL switching indication that indicates UL transmission switching on one antenna port may be received via RRC signaling. That is, for example, the UE may receive an information element indicating the state of the transmit chains (e.g., uplinkTxSwitching-DualUL-TxState), which may include a parameter or value that indicates to the UE that one transmission (e.g., oneT) is assumed to be supported on the carriers on each band (e.g., on the carriers one each band in band combination 106). The UE may then implement UL transmission switching on one antenna port based on the received parameter or value that indicates to the UE that one transmission (e.g., oneT) is assumed. When implementing UL transmission switching on one antenna port, the UE may use a single transmit chain for an UL transmission switch to a new carrier being scheduled. By contrast, for example, if a parameter or value that indicates to the UE that two transmissions (e.g., twoT) are assumed to be supported on the carrier when receiving the information element indicating the state of the transmit chains (e.g., uplinkTxSwitching-DualUL-TxState), then the UE may implement UL transmission switching on two antenna ports for the carrier. When implementing UL transmission switching on two antenna port, the UE may use both transmit chains for an UL transmission switch to the new carrier being scheduled.

In some embodiments of the method 200, for example, the UE may receive a first DCI 302 that triggers a first UL transmission switch from one of the first band 306 (e.g., Band A) or the second band 308 (e.g., Band B) to the third band 310 (e.g., Band C). However, the UE may need to determine which of the transmit chains to utilize when performing the first UL transmission switch. That is, for example, the UE may utilize the first transmit chain with the first band 306 (e.g., Band A) configured thereon to perform the first UL transmission switch to the third band 310 (e.g., Band C). Additionally or alternatively, the UE may utilize the second transmit chain with the second band 308 (e.g., Band B) configured thereon to perform the first UL transmission switch to the third band 310 (e.g., Band C).

In some embodiments of the method 200, for example, the UE may switch the first band 306 (e.g., Band A) configured on the first transmit chain to the third band 310 (e.g., Band C) based at least in part on an UL switching period determination or a network configuration indicating an UL switch from the first band 306 (e.g., Band A) configured on the first transmit chain. That is, for example, the UE may make the UL switching period determination in determining whether to switch the first band 306 (e.g., Band A) configured on the first transmit chain or the second band 308 (e.g., Band B) configured on the first transmit chain to the third band 310 (e.g., Band C).

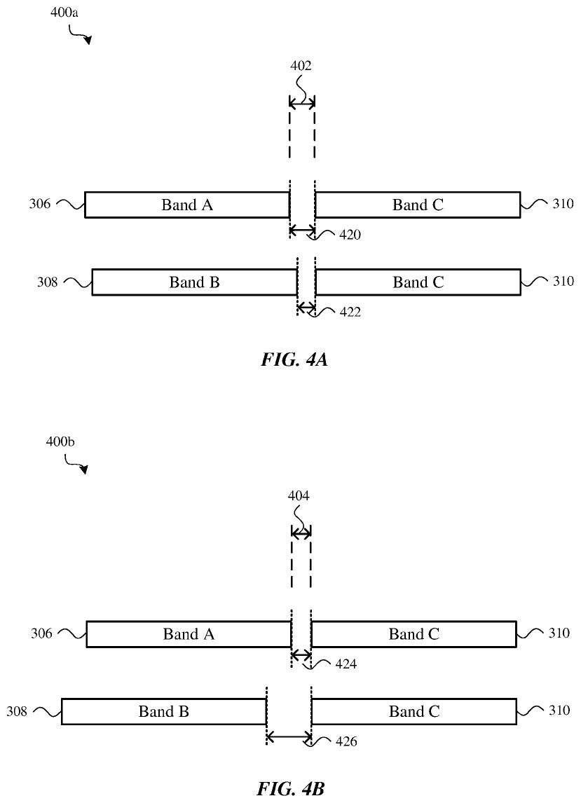

FIGS. 4A and 4B illustrate examples of UL switching gaps for band pairs associated with UL transmission switching. With further reference to the examples of FIGS. 4A and 4B, various aspects of the method 200 may be illustrated, for example, in UL switching gap diagram 400a and UL switching gap diagram 400b in conjunction with UL switching scenario 300 of FIG. 3.

As illustrated in the UL switching gap diagram 400a of FIG. 4A, in some embodiments of the method 200, for example, the UE may make the UL switching period determination to be a maximum UL switching period 402 for the existing bands that may be switched to the scheduled third band 310 (e.g., Band C). That is, for example, the UE may determine a maximum UL switching period 402 and switch to the band pair that provides a longest switching gap. In some embodiments, the UE may determine that the maximum UL switching period 402 as a maximum switching gap between a first UL switching gap 420 for UL switching between the first band 306 (e.g., Band A) and the third band 310 (e.g., Band C) and a second UL switching gap 422 for UL switching between the second band 308 (e.g., Band B) and the third band 310 (e.g., Band C).

The maximum UL switching period 402 may correspond to the first UL switching gap 420 for UL switching between the first band 306 (e.g., Band A) and the third band 310 (e.g., Band C) as illustrated in the UL switching gap diagram 400a of FIG. 4A. Based at least in part on the UL switching period determination as the maximum UL switching period 402, the UE may switch the first band 306 (e.g., Band A) configured on the first transmit chain to the third band 310 (e.g., Band C) in accordance with some embodiments.

As illustrated in the UL switching gap diagram 400b of FIG. 4B, in some embodiments of the method 200, for example, the UE may make the UL switching period determination to be a minimum UL switching period 404 for the existing bands that may be switched to the scheduled third band 310 (e.g., Band C). That is, for example, the UE may determine a minimum UL switching period 404 and switch to the band pair that provides a shortest switching gap. In some embodiments, the UE may determine that the minimum UL switching period 404 as a minimum switching gap between a first UL switching gap 424 for UL switching between the first band 306 (e.g., Band A) and the third band 310 (e.g., Band C) and a second UL switching gap 426 for UL switching between the second band 308 (e.g., Band B) and the third band 310 (e.g., Band C).

The minimum UL switching period 404 may correspond to the first UL switching gap 420 for UL switching between the first band 306 (e.g., Band A) and the third band 310 (e.g., Band C) as illustrated in the UL switching gap diagram 400b of FIG. 4B. Based at least in part on the UL switching period determination as the minimum UL switching period 404, the UE may switch the first band 306 (e.g., Band A) configured on the first transmit chain to the third band 310 (e.g., Band C) in accordance with some embodiments.

In some embodiments of the method 200, for example, the UE may receive a network configuration indicating an UL switch from the first band 306 (e.g., Band A) configured on the first transmit chain. In some embodiments, the network configuration indicating an UL switch from the first band 306 (e.g., Band A) configured on the first transmit chain may be a RRC configuration. That is, for example, the network configuration indicating an UL switch from the first band 306 (e.g., Band A) configured on the first transmit chain may be included in an UL switching information element or parameter (e.g., an existing information element or parameter such as CellGroupConfig, uplinkTxSwitching, uplinkTxSwitchingOption, etc. or a newly defined information element).

In some embodiments, the network configuration indicating an UL switch from the first band 306 (e.g., Band A) configured on the first transmit chain may be the received first DCI 302. That is, for example, the UE may receive the first DCI 302 with an explicit indication that the first UL transmission switch is an UL switch from the first band 306 (e.g., Band A) to the third band 310 (e.g., Band C). Additionally or alternatively, the first DCI 302 may include one or more new bit field indicators that signal to the UE, for example, that the first band 306 (e.g., Band A) configured on the first transmit chain is to be switched to the third band 310 (e.g., Band C). Additionally or alternatively, the first DCI 302 may be an existing DCI format (e.g., DCI formats 0_0, 0_1, and 0_2 specified in 3GPP TS 38.212) that when interpreted by the UE in light of other band and UL switching configurations, for example, that the first band 306 (e.g., Band A) configured on the first transmit chain is to be switched to the third band 310 (e.g., Band C).

In some embodiments of the method 200, for example, a UE may refrain from UL transmission on the second band 308 (e.g., Band B) configured on the second transmit chain during an UL switching period for UL switching between the first band 306 (e.g., Band A) and the third band 310 (e.g., Band C). That is, for example, based at least in part on the UL switching period determination (e.g., as the maximum UL switching period 402 or the minimum UL switching period 404) or a network configuration indicating an UL switch from the first band 306 (e.g., Band A) configured on the first transmit chain, the second band 308 (e.g., Band B) configured on the second transmit chain will remain unchanged. However, in some embodiments, may refrain from UL transmission on the second band 308 (e.g., Band B) during the UL switching period for UL switching between the first band 306 (e.g., Band A).

That is, for example, the UE may refrain from UL transmission on the second band 308 (e.g., Band B) during the first UL switching gap 420 for UL switching between the first band 306 (e.g., Band A) and the third band 310 (e.g., Band C) in the UL switching gap diagram 400b of FIG. 4B. In some embodiments, the UE may refrain from UL transmission on the second band 308 (e.g., Band B) during the first UL switching gap 424 for UL switching between the first band 306 (e.g., Band A) and the third band 310 (e.g., Band C) in the UL switching gap diagram 400b of FIG. 4B.

In some embodiments of the method 200, for example, the UE may receive an associated band configuration corresponding to a plurality of UL bands. That is, for example, the plurality of UL bands in the associated band configuration may correspond to one or more UL band combinations (e.g., one or more UL band combinations involving Band E, Band F, Band G and Band H). In other words, the associated band configuration may be exclusive of the first band 306 (e.g., Band A), the second band 308 (e.g., Band B), and the third band 310 (e.g., Band C).

For example, although the UE may be configured for the band combination 106 indicating support for UL transmissions in Band A, Band B, Band C and Band D, the UE may not receive an associated band configuration for those bands in the band combination 106. That is, while the UE may support associated bands with respect to certain bands, band pairs, or band combinations, the UE may not be able to support such associated band functionality for the band combination 106 indicating support for UL transmission in Band A, Band B, Band C, and Band D. However, the UE may be configured for another band combination indicating support for UL transmission in Band E, Band F, Band G, and Band H and may be capable of supporting such associated band functionality for bands, band pairs, or the other band combination. Thus, at a later time when the UE is instructed to switch to one or more of Band E, Band F, Band G, and Band H for UL transmissions, the UE may perform UL switching with associated bands.

In some embodiments, the UE may receive an associated band configuration corresponding to a plurality of UL bands, the plurality of UL bands corresponding to one or more UL band combinations including a first band combination including at least one of the first band 306 (e.g., Band A) or the second band 308 (e.g., Band B), and the plurality of UL bands absent an indication of the third band 310 (e.g., Band C). That is, for example, because the UE is switching to the third band 310 (e.g., Band C), and the third band 310 (e.g., Band C) is not supported by the UE for associated band functionality and not identified in an associated band configuration, the UE may switch to the third band 310 (e.g., Band C) absent any associated band considerations. Similarly, for example, the UE may receive an associated band configuration corresponding to a plurality of UL bands, the plurality of UL bands corresponding to a second UL band combination including the third band 310 (e.g., Band C) and absent an indication of an associated band for the third band 310 (e.g., Band C). That is, for example, because the UE is switching to the third band 310 (e.g., Band C), and the third band 310 (e.g., Band C) is not supported by the UE for associated band functionality and not identified in an associated band configuration (although identified in a band combination that includes a band that does support associated band functionality), the UE may switch to the third band 310 (e.g., Band C) absent any associated band considerations.

In other words, in some embodiments, associated band functionality may be implemented (or conversely not implemented) on a per UE, per band combination, per band pair per band combination, or per band per band pair per band combination. Additionally or alternatively, the UE may report a first UE capability (e.g., an associated band capability) to the network. For example, the first UE capability may indicate support to switch a transmit chain to an associated band. The first UE capability may be reported to the network on a per UE, per band combination, per band pair per band combination, or per band per band pair per band combination. That is, for example, in various UL switching cases, when the UE has two transmit chains for UL transmissions and each of the transmit chains is associated with a different band (e.g., e.g., the first band 306 (e.g., Band A) configured on the first transmit chain and the second band 308 (e.g., Band B) configured on the second transmit chain), the UE may be explicitly triggered by network to switch one of the transmit chains to another band different from the two existing bands before the UL switching. For example, if the first UE capability is reported to the network in a manner that includes the third band 310 (e.g., Band C) in the capability indication to switch a transmit chain to an associated band, and the UE receives an associated band configuration that includes an entry {Band D for Band C} meaning that Band D is the associated band for Band C, then the UE may switch the first transmit chain to the third band 310 (e.g., Band C) and the second transmit chain to the fourth band 312 (e.g., Band D).

Additionally or alternatively, the UE may report a second UE capability (e.g., an unchanged band transmission capability) to the network. For example, the second UE capability may indicate support to transmit on an unchanged transmit chain during an UL switching period for a switching transmit chain. The second UE capability may be reported to the network on a per UE, per band combination, per band pair per band combination, or per band per band pair per band combination. That is, for example, in various UL switching cases, when the UE has two transmit chains for UL transmissions and each of the transmit chains is associated with a different band (e.g., e.g., the first band 306 (e.g., Band A) configured on the first transmit chain and the second band 308 (e.g., Band B) configured on the second transmit chain), the UE may switch the first band 306 (e.g., Band A) configured on the first transmit chain to the third band 310 (e.g., Band C). In some embodiments, the second band 308 (e.g., Band B) configured on the second transmit chain may remain configured on the second transmit chain and an UL transmission may be explicitly triggered by network on a carrier in the second band 308 (e.g., Band B) while the first transmit chain is switching from the first band 306 (e.g., Band A) to the third band 310 (e.g., Band C). For example, if the second UE capability is reported to the network in a manner that includes the second band 308 (e.g., Band B) in the capability indication supporting to transmit on an unchanged transmit chain during an UL switching period for a switching transmit chain, and the UE receives a second DCI (e.g., different from the first DCI 302) or other trigger for a second UL transmission on the second band 308 (e.g., Band B), then the UE may transmit the second UL transmission on the second band 308 (e.g., Band B) configured on the second transmit chain during the UL switching period for the first transmit chain switching the first band 306 (e.g., Band A) to the third band 310 (e.g., Band C).

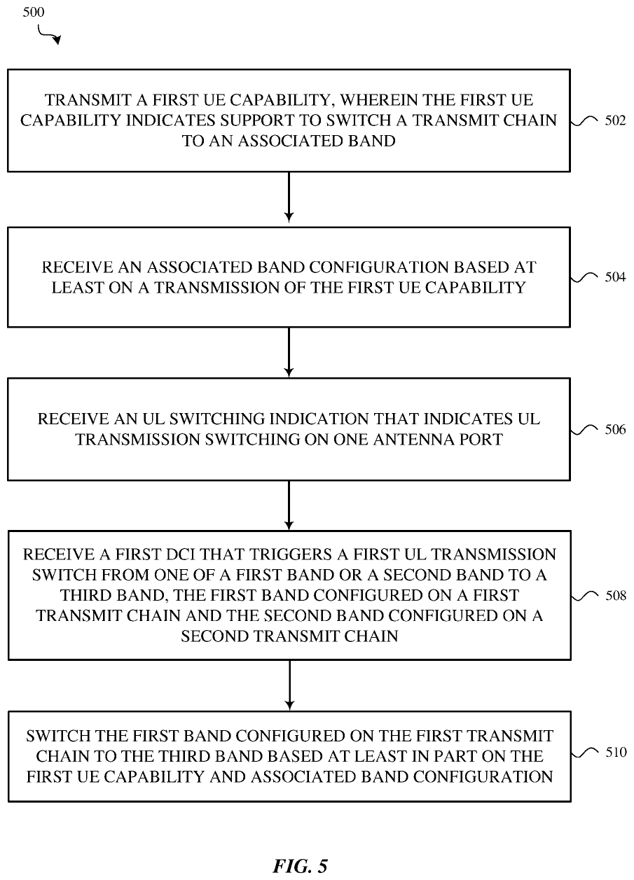

FIG. 5 illustrates an example method 500 of wireless communication by a UE, in accordance with some embodiments and various aspects of the present disclosure. The method 500 may be performed by the UE 102 described with reference to FIG. 1 or by other UEs described herein. The method 500 may be performed using a processor, a set of transceivers (e.g., one or more transceivers) or other components of a UE.

At 502, the method 500 may include transmitting a first UE capability. For example, the first UE capability may indicate support to switch a transmit chain to an associated band.

At 504, the method 500 may include receiving an associated band configuration based at least on a transmission of the first UE capability.

At 506, the method 500 may include receiving an UL switching indication that indicates UL transmission switching on one antenna port.

At 508, the method 500 may include receiving a first DCI that triggers a first UL transmission switch from one of a first band or a second band to a third band. For example, the first band may be configured on a first transmit chain and the second band may be configured on a second transmit chain.

At 510, the method 500 may include switching the first band configured on the first transmit chain to the third band based at least in part on the first UE capability and associated band configuration.

With reference to the example of FIG. 3, various aspects of the method 500 may be illustrated in UL switching scenario 300. In some embodiments of the method 500, for example, in some embodiments of the method 500, for example, the UE may perform UL transmissions in accordance with band combination 106, which may include a first band 306 (e.g., Band A), a second band 308 (e.g., Band B), a third band 310 (e.g., Band C) and fourth band 312 (e.g., Band D). That is, for example, the UE may utilize one or both of a first transmit chain and a second transmit chain for UL transmissions on one or more carriers in one or more of the first band 306 (e.g., Band A), the second band 308 (e.g., Band B), the third band 310 (e.g., Band C), or the fourth band 312 (e.g., Band D). In UL switching scenario 300, the UE may have an existing UL transmission on the first band 306 (e.g., Band A) configured on the first transmit chain and an existing UL transmission on the second band 308 (e.g., Band B) configured on the second transmit chain.

In some embodiments, the UE may transmit the first UE capability (e.g., via an RRC configuration to the network). The first UE capability may indicate to the network that the UE supports switching a transmit chain to an associated band. The UE may receive an associated band configuration from the network. For example, the UE may receive the associated band configuration 108, which may indicate {Band B for Band A}, {Band A for Band B}, {Band A for Band C} and {Band C for Band D}. In some embodiments, the UE may receive various associated band configurations as described herein. In some embodiments, the network may transmit and the UE may receive the associated band configuration based at least on the UE transmitting the first UE capability to the network.

In some embodiments of the method 500, for example, the UE may receive an UL switching indication that indicates UL transmission switching on one antenna port. In some embodiments, the UL switching indication that indicates UL transmission switching on one antenna port may be received via RRC signaling. That is, for example, the UE may receive an information element indicating the state of the transmit chains (e.g., uplinkTxSwitching-DualUL-TxState), which may include a parameter or value that indicates to the UE that one transmission (e.g., oneT) is assumed to be supported on the carriers on each band (e.g., on the carriers one each band in band combination 106).

In some embodiments of the method 500, for example, the UE may receive a first DCI 302 that triggers a first UL transmission switch from one of the first band 306 (e.g., Band A) or the second band 308 (e.g., Band B) to the third band 310 (e.g., Band C). However, the UE may need to determine which of the transmit chains to utilize when performing the first UL transmission switch. That is, for example, the UE may utilize the first transmit chain with the first band 306 (e.g., Band A) configured thereon to perform the first UL transmission switch to the third band 310 (e.g., Band C). Additionally or alternatively, the UE may utilize the second transmit chain with the second band 308 (e.g., Band B) configured thereon to perform the first UL transmission switch to the third band 310 (e.g., Band C).

In some embodiments of the method 500, for example, the UE may switch the first band 306 (e.g., Band A) configured on the first transmit chain to the third band 310 (e.g., Band C) based at least in part on the first UE capability and associated band configuration. It is to be understood that, in some embodiments, the UE may switch the second band 308 (e.g., Band B) configured on the second transmit chain to the third band 310 (e.g., Band C) based at least in part on the first UE capability and associated band configuration. That is, for example, the UE may perform the first UL transmission switch based on the UE indicating support for switching a transmit chain to an associated band and the associated band configuration received by the UE from the network in determining whether to switch the first band 306 (e.g., Band A) configured on the first transmit chain or the second band 308 (e.g., Band B) configured on the first transmit chain to the third band 310 (e.g., Band C).

In some embodiments of the method 500, for example, the UE may determine that the associated band configuration includes a first band pair indication (e.g., {Band B for Band C}). That is, for example, the first band pair indication may indicate to the UE that the second band 308 (e.g., Band B) is for the third band 310 (e.g., Band C). Because the second band 308 (e.g., Band B) is to be associated with the third band 310 (e.g., Band C) after the UL switch for the third band 310 (e.g., Band C), the UE may determine to switch the first band 306 (e.g., Band A) configured on the first transmit chain to the third band 310 (e.g., Band C) so that the second band 308 (e.g., Band B) will remain configured on the second transmit chain and for UL transmission operations with the third band 310 (e.g., Band C) configured on the first transmit chain after the first UL transmission switch. In other words, the UE determines the transmit chain for the first UL transmission switch based at least in part on determining that the associated band configuration includes the first band pair indication (e.g., {Band B for Band C}).

In some embodiments of the method 500, for example, the UE may determine that the associated band configuration includes a second band pair indication (e.g., {Band D for Band C}). That is, for example, the second band pair indication is different from the second band pair indication, and the second band pair indication may indicate to the UE that the fourth band 312 (e.g., Band D) is for the third band 310 (e.g., Band C). Because the fourth band 312 (e.g., Band D) is to be associated with the third band 310 (e.g., Band C) after the UL switch for the third band 310 (e.g., Band C), the UE may determine to switch the first band 306 (e.g., Band A) configured on the first transmit chain to the third band 310 (e.g., Band C) and also switch the second band 308 (e.g., Band B) configured on the second transmit chain to fourth band 312 (e.g., Band D). In this manner, UL transmission operations associated with the third band 310 (e.g., Band C) configured on the first transmit chain and the fourth band 312 (e.g., Band D) configured on the second transmit chain may be performed after the first UL transmission switch. In other words, the UE determines the transmit chain for the first UL transmission switch based at least in part on determining that the associated band configuration includes the second band pair indication (e.g., {Band D for Band C}).

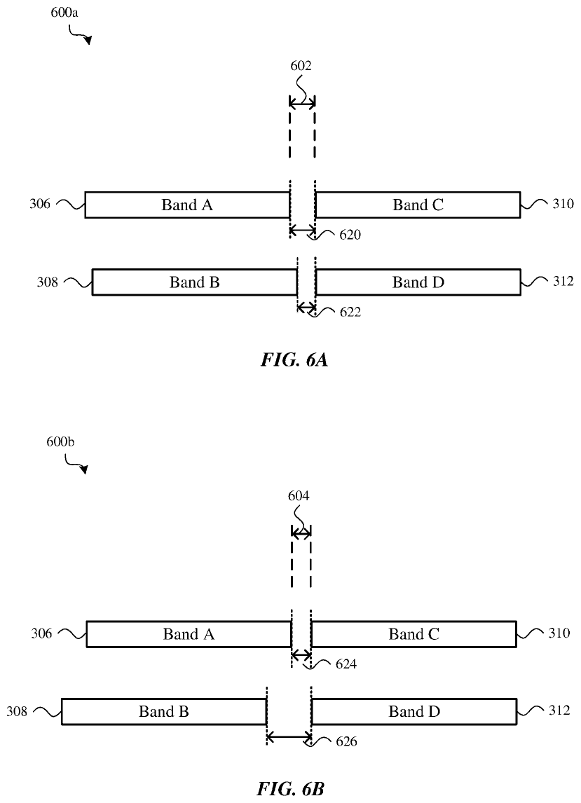

It is to be appreciated that in some embodiments, the UE may make further determinations as to whether the UE should switch a transmit chain to an associated band. FIGS. 6A and 6B illustrate examples of UL switching gaps for band pairs associated with UL transmission switching. With further reference to the examples of FIGS. 6A and 6B, various aspects of the method 500 may be illustrated, for example, in UL switching gap diagram 600a and UL switching gap diagram 600b in conjunction with UL switching scenario 300 of FIG. 3.

As illustrated in the UL switching gap diagram 600a of FIG. 6A, in some embodiments of the method 500, for example, the UE may determine a maximum UL switching period 602 for the existing bands that may be switched to the scheduled third band 310 (e.g., Band C). That is, for example, the UE may determine that a first UL switching gap 620 for UL switching between the first band 306 (e.g., Band A) and the third band 310 (e.g., Band C) is longer than or equal to a second UL switching gap 622 for UL switching between the second band 308 (e.g., Band B) and the fourth band 312 (e.g., Band D). In some embodiments, the UE may switch the second band 308 (e.g., Band B) configured on the second transmit chain to the fourth band 312 (e.g., Band D) based at least in part on a determination that the associated band configuration includes the second band pair indication (e.g., {Band D for Band C}) and a determination that the first UL switching gap 620 is longer than or equal to the second UL switching gap 622. In this manner, for example, the UE and/or network may balance transmit chain RF switching complexities such as UE processing procedure time for both transmit chains to be reconfigured on new bands (e.g., preference for a longer UL switching period) with the additional UL transmission opportunity (e.g., preference for a shorter UL switching period).

Continuing with the UL switching gap diagram 600a of FIG. 6A, in some embodiments of the method 500, for example, the UE may determine that the first UL switching gap 620 for UL switching between the first band 306 (e.g., Band A) and the third band 310 (e.g., Band C) is longer than a second UL switching gap 622 for UL switching between the second band 308 (e.g., Band B) and the fourth band 312 (e.g., Band D). In some embodiments, the UE may switch the second band 308 (e.g., Band B) configured on the second transmit chain to the third band 310 (e.g., Band C) based at least in part on the determination that the associated band configuration includes the second band pair indication (e.g., {Band D for Band C}) and a determination that the first UL switching gap 620 is longer than the second UL switching gap 622. The result of this UL switching example in which first band 306 (e.g., Band A) configured on the first transmit chain is switched to the third band 310 (e.g., Band C) and the second band 308 (e.g., Band B) configured on the second transmit chain is also switched to the third band 310 (e.g., Band C) is effectively a dual UL switch supporting two antenna ports on the third band 310 (e.g., Band C).

That is, the UE may use both transmit chains for UL transmissions to the new carrier being scheduled on third band 310 (e.g., Band C) after this effective dual UL switch is implemented. In some embodiments, this effective dual UL switch when the parameter or value indicates to the UE that one transmission (e.g., oneT) is too assumed may be made based at least in part on the UE reporting the first UE capability (e.g., an indication to the network that the UE supports and/or is capable of switching a transmit chain to an associated band).

As illustrated in the UL switching gap diagram 600b of FIG. 6B, in some embodiments of the method 500, for example, the UE may determine a minimum UL switching period 604 for the existing bands that may be switched to the scheduled third band 310 (e.g., Band C). That is, for example, the UE may determine that a first UL switching gap 624 for UL switching between the first band 306 (e.g., Band A) and the third band 310 (e.g., Band C) is shorter than a second UL switching gap 626 for UL switching between the second band 308 (e.g., Band B) and the fourth band 312 (e.g., Band D). In some embodiments, the UE may switch the second band 308 (e.g., Band B) configured on the second transmit chain to the fourth band 312 (e.g., Band D) based at least in part on a determination that the associated band configuration includes the second band pair indication (e.g., {Band D for Band C}) and a determination that the first UL switching gap 624 is shorter than the second UL switching gap 626.

Continuing with the UL switching gap diagram 600b of FIG. 6B, in some embodiments of the method 500, for example, the UE may determine that the first UL switching gap 624 for UL switching between the first band 306 (e.g., Band A) and the third band 310 (e.g., Band C) is shorter than a second UL switching gap 626 for UL switching between the second band 308 (e.g., Band B) and the fourth band 312 (e.g., Band D). In some embodiments, the UE may switch the second band 308 (e.g., Band B) configured on the second transmit chain to the third band 310 (e.g., Band C) based at least in part on the determination that the associated band configuration includes the second band pair indication (e.g., {Band D for Band C}) and a determination that the first UL switching gap 620 is shorter than the second UL switching gap 626. Again, the result of this UL switching example in which first band 306 (e.g., Band A) configured on the first transmit chain is switched to the third band 310 (e.g., Band C) and the second band 308 (e.g., Band B) configured on the second transmit chain is also switched to the third band 310 (e.g., Band C) is effectively a dual UL switch supporting two antenna ports on the third band 310 (e.g., Band C).

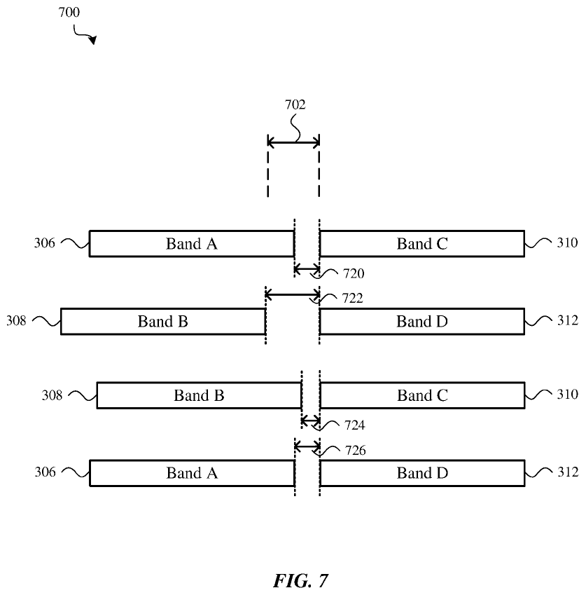

FIG. 7 illustrates an example of UL switching gaps for band pairs associated with UL transmission switching. With further reference to the example of FIG. 7, various aspects of the method 500 may be illustrated, for example, in UL switching gap diagram 700 conjunction with UL switching scenario 300 of FIG. 3. In some embodiments of the method 500, for example, the UE may determine a first UL switching period 702 as a maximum of one or more band pairs in a band combination (e.g., the band combination 106). For example, the first UL switching period 702 may be a maximum of the UL switching gaps for each of the possible band pair combinations that could be switched by both transmit chains when UL transmission switching with associated band is performed. As illustrated in FIG. 7, for example, the UE may determine a maximum of: a first UL switching gap 720 for UL switching between the first band 306 (e.g., Band A) and the third band 310 (e.g., Band C); a second UL switching gap 722 for UL switching between the second band 308 (e.g., Band B) and the fourth band 312 (e.g., Band D); a third UL switching gap 724 for UL switching between the second band 308 (e.g., Band B) and the third band 310 (e.g., Band C); and a fourth UL switching gap 726 for UL switching between the first band 306 (e.g., Band A) and the fourth band 312 (e.g., Band D). As illustrated in the example of FIG. 7, the second UL switching gap 722 is the maximum is determined as the first UL switching period 702.

In some embodiments, the UE may switch, during the first UL switching period 702, the first band 306 (e.g., Band A) configured on the first transmit chain to the third band 310 (e.g., Band C) and second band 308 (e.g., Band B) configured on the second transmit chain to the fourth band 312 (e.g., Band D) based at least in part on the determination that the associated band configuration includes the second band pair indication (e.g., {Band D for Band C}).

In some embodiments of the method 500, for example, the UE may report the first UE capability with respect to various granularities. That is, for example, the UE may transmit the first UE capability as a per UE capability. In some embodiments, the UE may transmit the first UE capability as a per band combination capability. That is, for example, the UE may indicate support to switch a transmit chain to an associated band for a first band combination (e.g., the band combination 106) including the first band 306 (e.g., Band A), the second band 308 (e.g., Band B), the third band 310 (e.g., Band C) and the fourth band 312 (e.g., Band D).

In some embodiments, the UE may transmit the first UE capability as a per band pair per band combination capability. That is, for example, the UE may indicate support to switch a transmit chain to an associated band for a first band pair (e.g., Band B and Band C) including the third band 310 (e.g., Band C). The first band pair (e.g., Band B and Band C) may be associated with the first band combination (e.g., the band combination 106) including the first band 306 (e.g., Band A), the second band 308 (e.g., Band B), the third band 310 (e.g., Band C) and the fourth band 312 (e.g., Band D).

In some embodiments, the UE may transmit the first UE capability as per band per band pair per band combination capability. That is, for example, the UE may indicate support to switch a transmit chain to an associated band for a band (e.g., Band C) of a first band pair (e.g., Band B and Band C) including the third band 310 (e.g., Band C). The first band pair (e.g., Band B and Band C) may be associated with the first band combination (e.g., the band combination 106) including the first band 306 (e.g., Band A), the second band 308 (e.g., Band B), the third band 310 (e.g., Band C) and the fourth band 312 (e.g., Band D).

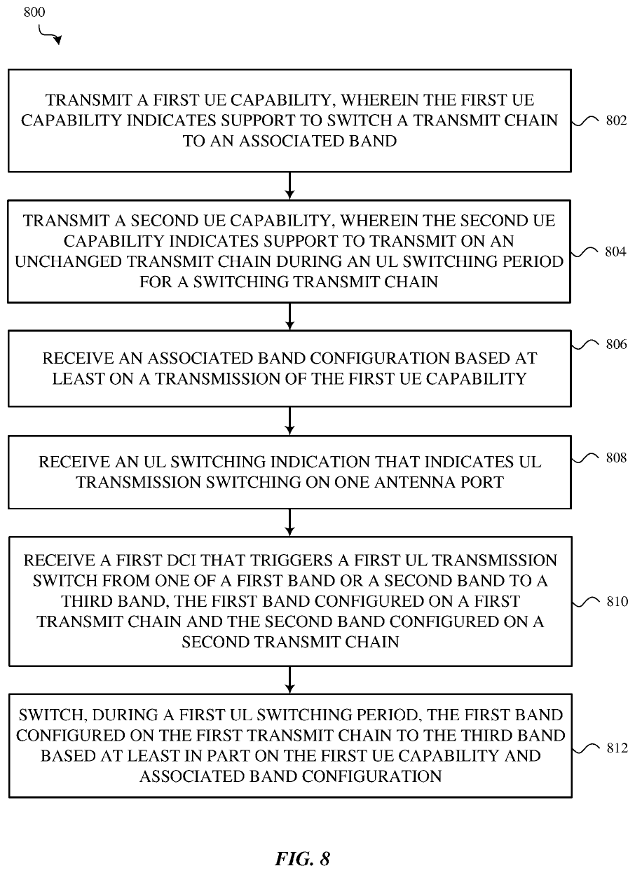

FIG. 8 illustrates an example method 800 of wireless communication by a UE, in accordance with some embodiments and various aspects of the present disclosure. The method 800 may be performed by the UE 102 described with reference to FIG. 1 or by other UEs described herein. The method 800 may be performed using a processor, a set of transceivers (e.g., one or more transceivers) or other components of a UE.

At 802, the method 800 may include transmitting a first UE capability. For example, the first UE capability may indicate support to switch a transmit chain to an associated band.

At 804, the method 800 may include transmitting a second UE capability. For example, the second UE capability may indicate support to transmit on an unchanged transmit chain during an UL switching period for a switching transmit chain.

At 806, the method 800 may include receiving an associated band configuration based at least on a transmission of the first UE capability.

At 808, the method 800 may include receiving an UL switching indication that indicates UL transmission switching on one antenna port.

At 810, the method 800 may include receiving a first DCI that triggers a first UL transmission switch from one of a first band or a second band to a third band. For example, the first band may be configured on a first transmit chain and the second band may be configured on a second transmit chain.

At 812, the method 800 may include switching, during a first UL switching period, the first band configured on the first transmit chain to the third band based at least in part on the associated band configuration.

With reference to the example of FIG. 3, various aspects of the method 800 may be illustrated in UL switching scenario 300. In some embodiments of the method 800, for example, in some embodiments of the method 800, for example, the UE may perform UL transmissions in accordance with band combination 106, which may include a first band 306 (e.g., Band A), a second band 308 (e.g., Band B), a third band 310 (e.g., Band C) and fourth band 312 (e.g., Band D). That is, for example, the UE may utilize one or both of a first transmit chain and a second transmit chain for UL transmissions on one or more carriers in one or more of the first band 306 (e.g., Band A), the second band 308 (e.g., Band B), the third band 310 (e.g., Band C), or the fourth band 312 (e.g., Band D). In UL switching scenario 300, the UE may have an existing UL transmission on the first band 306 (e.g., Band A) configured on the first transmit chain and an existing UL transmission on the second band 308 (e.g., Band B) configured on the second transmit chain.

In some embodiments, the UE may transmit the first UE capability (e.g., via an RRC configuration to the network). The first UE capability may indicate to the network that the UE supports switching a transmit chain to an associated band. In some embodiments, the UE may transmit the second UE capability (e.g., via an RRC configuration to the network). The second UE capability may indicate to the network that the UE supports transmission on an unchanged transmit chain during an UL switching period for a switching transmit chain. In some embodiments, the UE may transmit both the first UE capability and the second UE capability. However, in some embodiments, the UE may transmit the first UE capability, but not the second UE capability, and in some embodiments, the UE may transmit the second UE capability, but not the first UE capability.

The UE may receive an associated band configuration from the network. For example, the UE may receive the associated band configuration 108, which may indicate {Band B for Band A}, {Band A for Band B}, {Band A for Band C} and {Band C for Band D}. In some embodiments, the UE may receive various associated band configurations as described herein. In some embodiments, the network may transmit and the UE may receive the associated band configuration based at least on the UE transmitting the first UE capability to the network.

In some embodiments of the method 800, for example, the UE may receive an UL switching indication that indicates UL transmission switching on one antenna port. In some embodiments, the UL switching indication that indicates UL transmission switching on one antenna port may be received via RRC signaling. That is, for example, the UE may receive an information element indicating the state of the transmit chains (e.g., uplinkTxSwitching-DualUL-TxState), which may include a parameter or value that indicates to the UE that one transmission (e.g., oneT) is assumed to be supported on the carriers on each band (e.g., on the carriers one each band in band combination 106).

In some embodiments of the method 800, for example, the UE may receive a first DCI 302 that triggers a first UL transmission switch from one of the first band 306 (e.g., Band A) or the second band 308 (e.g., Band B) to the third band 310 (e.g., Band C). However, the UE may need to determine which of the transmit chains to utilize when performing the first UL transmission switch. That is, for example, the UE may utilize the first transmit chain with the first band 306 (e.g., Band A) configured thereon to perform the first UL transmission switch to the third band 310 (e.g., Band C). Additionally or alternatively, the UE may utilize the second transmit chain with the second band 308 (e.g., Band B) configured thereon to perform the first UL transmission switch to the third band 310 (e.g., Band C). In some embodiments, the UE may need to determine whether to transmit on the unchanged transmit chain during the UL switching period for the switching transmit chain. That is, for example, if one of the transmit chains remains unchanged when the UL switch is performed according to the first DCI 302.

In some embodiments of the method 800, for example, the UE may switch the first band 306 (e.g., Band A) configured on the first transmit chain to the third band 310 (e.g., Band C) based at least in part on the first UE capability and associated band configuration. It is to be understood that, in some embodiments, the UE may switch the second band 308 (e.g., Band B) configured on the second transmit chain to the third band 310 (e.g., Band C) based at least in part on the first UE capability and associated band configuration. That is, for example, the UE may perform the first UL transmission switch based on the UE indicating support for switching a transmit chain to an associated band and the associated band configuration received by the UE from the network in determining whether to switch the first band 306 (e.g., Band A) configured on the first transmit chain or the second band 308 (e.g., Band B) configured on the first transmit chain to the third band 310 (e.g., Band C).

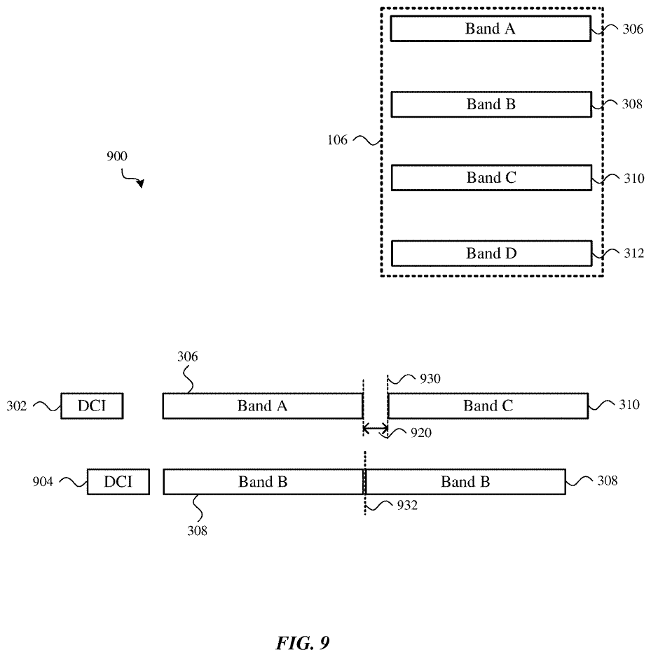

FIG. 9 illustrates an example of UL transmission switching for wireless communication between a UE and one or more network devices. The UL transmission switch may be performed by the UE 102 described with reference to FIG. 1 or by other UEs described herein, and in conjunction or cooperation with the one or more network devices 104 with reference to FIG. 1 or by other network devices described herein. With reference to the example of FIG. 9, various aspects of the method 800 may be illustrated in UL switching scenario 900.

In some embodiments of the method 800, for example, the UE may receive a second DCI 904 that triggers a second UL transmission on the second band 308 (e.g., Band B) at a second UL transmission starting time 932 (e.g., T_{0_2}). In some embodiments, the second UL transmission starting time 932 (e.g., T_{0_2}) is different from a first UL transmission starting time 930 (e.g., T_{0_1}) at which a first UL transmission associated with the first UL transmission switch. That is, for example, the first UL transmission scheduled by the first DCI 302 may start at first UL transmission starting time 930 (e.g., T_{0_1}). The second UL transmission scheduled by the second DCI 904 may start earlier in time at the second UL transmission starting time 932 (e.g., T_{0_2}) such that the second UL transmission occurs (at least partially) during a first UL switching gap 920 for UL switching between the first band 306 (e.g., Band A) and the third band 310 (e.g., Band C). That is, for example, the UE may transmit, during the first UL switching period (e.g., the first UL switching gap 920), the second UL transmission on the second band 308 (e.g., Band B) configured on the second transmit chain based at least in part on the second UE capability (e.g., indicating support or capability to transmit on the unchanged transmit chain during the UL switching period for a switching transmit chain). In this manner, for example, the UE and/or network may prioritize additional UL transmission opportunities over a dual UL switching, particularly when the unchanged transmit chain is configured with a band that is the associated band for the switching transmit chain (e.g., {Band B for Band C}).

In some embodiments of the method 800, for example, the UE may report the second UE capability with respect to various granularities. That is, for example, the UE may transmit the second UE capability as a per UE capability. In some embodiments, the UE may transmit the second UE capability as a per band combination capability. That is, for example, the UE may indicate support to transmit on an unchanged transmit chain for a first band combination (e.g., the band combination 106) including the first band 306 (e.g., Band A), the second band 308 (e.g., Band B), the third band 310 (e.g., Band C) and the fourth band 312 (e.g., Band D).

In some embodiments, the UE may transmit the second UE capability as a per band pair per band combination capability. That is, for example, the UE may indicate support to transmit on an unchanged transmit chain for a first band pair (e.g., Band B and Band C) including the second band 308 (e.g., Band B). The first band pair (e.g., Band B and Band C) may be associated with the first band combination (e.g., the band combination 106) including the first band 306 (e.g., Band A), the second band 308 (e.g., Band B), the third band 310 (e.g., Band C) and the fourth band 312 (e.g., Band D).

In some embodiments, the UE may transmit the second UE capability as per band per band pair per band combination capability. That is, for example, the UE may indicate support to transmit on an unchanged transmit chain for a band (e.g., Band B) of a first band pair (e.g., Band B and Band C) including the second band 308 (e.g., Band B). The first band pair (e.g., Band B and Band C) may be associated with the first band combination (e.g., the band combination 106) including the first band 306 (e.g., Band A), the second band 308 (e.g., Band B), the third band 310 (e.g., Band C) and the fourth band 312 (e.g., Band D).

Embodiments contemplated herein include methods in the complementary context of methods 200, 500 and 800 with respect to a network device communicating with a UE. In some embodiments, a complementary context of method 200 may be performed by the network device 104 described with reference to FIG. 1 or by other network devices described herein. The complementary context of method 200 may be performed using a processor, a set of transceivers (e.g., one or more transceivers) or other components of a network device. For example, the complementary context of method 200 may include transmitting an UL switching indication that indicates UL transmission switching on one antenna port; transmitting a first DCI that triggers a first UL transmission switch from one of a first band or a second band to a third band, the first band configured on a first transmit chain and the second band configured on a second transmit chain; and receiving a first UL transmission on the third band responsive to the first DCI.

In some embodiments of the complementary context of method 200, for example, the network device may transmit a first UL switching gap for UL switching between the first band and the third band, a second UL switching gap for UL switching between the second band and the fourth band, a third UL switching gap for UL switching between the second band and the third band, and/or a fourth UL switching gap for UL switching between the first band and the fourth band. In some embodiments, the network device may transmit an associated band configuration corresponding to a plurality of UL bands, the plurality of UL bands corresponding to one or more UL band combinations exclusive of the first band, the second band, and the third band. In some embodiments, the network device may transmit an associated band configuration corresponding to a plurality of UL bands, the plurality of UL bands corresponding to one or more UL band combinations including a first band combination including at least one of the first band or the second band, and the plurality of UL bands absent an indication of the third band. In some embodiments, the network device may transmit an associated band configuration corresponding to a plurality of UL bands, the plurality of UL bands corresponding to a second UL band combination including the third band and absent an indication of an associated band for the third band. In some embodiments, the network device may transmit the UL switching indication that indicates UL transmission switching on one antenna port via RRC signaling.

In some embodiments, a complementary context of method 500 may be performed by the network device 104 described with reference to FIG. 1 or by other network devices described herein. The complementary context of method 500 may be performed using a processor, a set of transceivers (e.g., one or more transceivers) or other components of a network device. For example, the complementary context of method 500 may include receiving a first UE capability, wherein the first UE capability indicates support to switch a transmit chain to an associated band; transmitting an associated band configuration based at least on receiving the first UE capability; transmitting an UL switching indication that indicates UL transmission switching on one antenna port; transmitting a first DCI that triggers a first UL transmission switch from one of a first band or a second band to a third band, the first band configured on a first transmit chain of the UE and the second band configured on a second transmit chain of the UE; and receiving a first UL transmission on the third band responsive to the first DCI.

In some embodiments of the complementary context of method 500, for example, the network device may transmit a first UL switching gap for UL switching between the first band and the third band, a second UL switching gap for UL switching between the second band and the fourth band, a third UL switching gap for UL switching between the second band and the third band, and/or a fourth UL switching gap for UL switching between the first band and the fourth band. In some embodiments, the network device may receive the first UE capability as a per band combination capability.

In some embodiments, a complementary context of method 800 may be performed by the network device 104 described with reference to FIG. 1 or by other network devices described herein. The complementary context of method 800 may be performed using a processor, a set of transceivers (e.g., one or more transceivers) or other components of a network device. For example, the complementary context of method 800 may include receiving a first UE capability, wherein the first UE capability indicates support to switch a transmit chain to an associated band; receiving a second UE capability, wherein the second UE capability indicates support to transmit on an unchanged transmit chain during an UL switching period for a switching transmit chain; transmitting an associated band configuration based at least on a transmission of the first UE capability; transmitting an UL switching indication that indicates UL transmission switching on one antenna port; transmitting a first DCI that triggers a first UL transmission switch from one of a first band or a second band to a third band, the first band configured on a first transmit chain and the second band configured on a second transmit chain; and receiving a first UL transmission on the third band responsive to the first DCI.

In some embodiments of the complementary context of method 800, for example, the network device may transmit a second DCI that triggers a second UL transmission on the second band at a second UL transmission starting time. In some embodiments, the network device may receive during a first UL switching period, the second UL transmission on the second band based at least in part on the second UE capability. In some embodiments, the network device may receive the second UE capability as a per band combination capability.

Embodiments contemplated herein include an apparatus having means to perform one or more elements of the method 200, 500, or 800. In the context of method 200, 500, or 800, the apparatus may be, for example, an apparatus of a UE (such as a wireless device 1102 that is a UE, as described herein). As would be apparent given the benefit of the disclosure and embodiments described herein, in the complementary context of method 200, 500, or 800, the apparatus may be, for example, an apparatus of a network device (such as a network device 1120 that can be a network device of a RAN, as described herein).

Embodiments contemplated herein include one or more non-transitory computer-readable media storing instructions to cause an electronic device, upon execution of the instructions by one or more processors of the electronic device, to perform one or more elements of the method 200, 500, or 800. In the context of method 200, 500, or 800, the non-transitory computer-readable media may be, for example, a memory of a UE (such as a memory 1106 of a wireless device 1102 that is a UE, as described herein). As would be apparent given the benefit of the disclosure and embodiments described herein, in the complementary context of method 200, 500, or 800, the non-transitory computer-readable media may be, for example, a memory of a network device (such as a memory 1124 of a network device 1120 that can be a network device of a RAN, as described herein).

Embodiments contemplated herein include an apparatus having logic, modules, or circuitry to perform one or more elements of the method 200, 500, or 800. In the context of method 200, 500, or 800, the apparatus may be, for example, an apparatus of a UE (such as a wireless device 1102 that is a UE, as described herein). As would be apparent given the benefit of the disclosure and embodiments described herein, in the complementary context of method 200, 500, or 800, the apparatus may be, for example, an apparatus of a network device (such as a network device 1120 that can be a network device of a RAN, as described herein).

Embodiments contemplated herein include an apparatus having one or more processors and one or more computer-readable media, using or storing instructions that, when executed by the one or more processors, cause the one or more processors to perform one or more elements of the method 200, 500, or 800. In the context of method 200, 500, or 800, the apparatus may be, for example, an apparatus of a UE (such as a wireless device 1102 that is a UE, as described herein). As would be apparent given the benefit of the disclosure and embodiments described herein, in the complementary context of method 200, 500, or 800, the apparatus may be, for example, an apparatus of a network device (such as a network device 1120 that can be a network device of a RAN, as described herein).

Embodiments contemplated herein include a signal as described in or related to one or more elements of the method 200, 500, or 800.

Embodiments contemplated herein include a computer program or computer program product having instructions, wherein execution of the program by a processor causes the processor to carry out one or more elements of the methods 200, 500, or 800. In the context of method 200, 500, or 800, the processor may be a processor of a UE (such as a processor(s) 1104 of a wireless device 1102 that is a UE, as described herein), and the instructions may be, for example, located in the processor and/or on a memory of the UE (such as a memory 1106 of a wireless device 1102 that is a UE, as described herein). As would be apparent given the benefit of the disclosure and embodiments described herein, in the complementary context of method 200, 500, or 800, the processor may be a processor of a network device (such as a processor(s) 1122 of a network device 1120 that can be a network device of a RAN, as described herein), and the instructions may be, for example, located in the processor and/or on a memory of the network device (such as a memory 1124 of a network device 1120 that can be a network device of a RAN, as described herein). In some embodiments with respect to the complementary context of method 200, 500, or 800, the processor may be a processor of a CN (such as a CN 1024 that is a network device, as described herein), and the instructions may be, for example, located in the processor and/or on a memory of the CN (such as a memory of a CN 1024 that is a network device, as described herein).

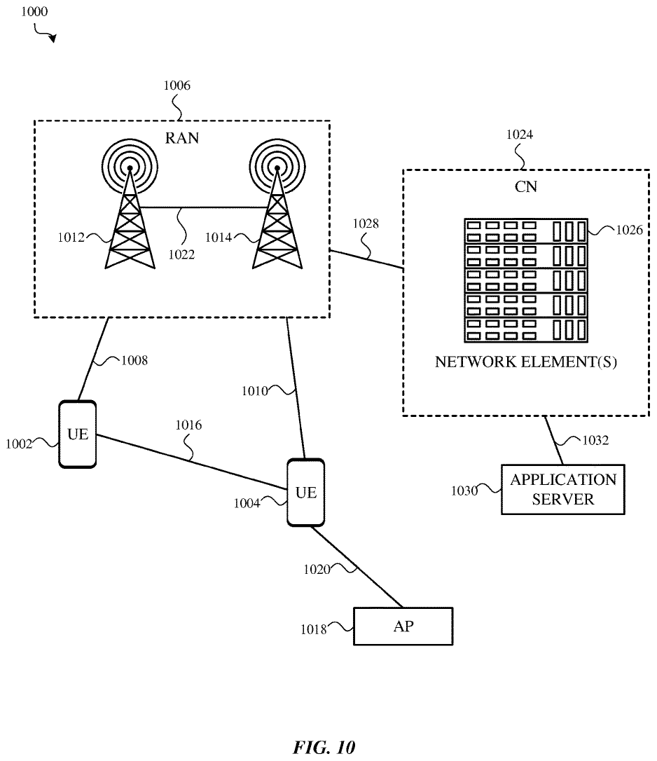

FIG. 10 illustrates an example architecture of a wireless communication system 1000, according to embodiments disclosed herein. The following description is provided for an example wireless communication system 1000 that operates in conjunction with the LTE system standards and/or 5G or NR system standards as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also include any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which includes a physical communications interface. The RAN 1006 can include one or more network devices, such as network device 1012 and network device 1014, that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. In some embodiments, for example, the transmit chains of the UE 1002 and UE 1004 may utilize the UL switching transmission techniques described herein to exchange communication data via the sidelink interface 1016. The UE 1004 is shown to be configured to access an access point (shown as AP 1018) via connection 1020. By way of example, the connection 1020 can include a local wireless connection, such as a connection consistent with any IEEE 502.11 protocol, wherein the AP 1018 may include a Wi-Fi® router. In this example, the AP 1018 may be connected to another network (for example, the Internet) without going through a CN 1024.

In embodiments, the UE 1002 and UE 1004 can be configured to communicate using OFDM communication signals with each other or with the network device 1012 and/or the network device 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for UL and ProSe or sidelink communications), although the scope of the embodiments is not limited in this respect. The OFDM signals can include a plurality of orthogonal subcarriers.

In some embodiments, all or parts of the network device 1012 or network device 1014 may be implemented as one or more software entities running on server computers as part of a virtual network. In addition, or in other embodiments, the network device 1012 or network device 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more network devices (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more network devices (e.g., two or more gNBs and the like) that connect to 5GC, between a network device 1012 (e.g., a gNB) connecting to 5GC and an eNB, and/or between two eNBs connecting to 5GC (e.g., CN 1024).

The RAN 1006 is shown to be communicatively coupled to the CN 1024. The CN 1024 may include one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the network device 1012 or network device 1014 and a serving gateway (S-GW), and the S1-MME interface, which is a signaling interface between the network device 1012 or network device 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the network device 1012 or network device 1014 and a user plane function (UPF), and the S1 control plane (NG-C) interface, which is a signaling interface between the network device 1012 or network device 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VoIP sessions, group communication sessions, etc.) for the UE 1002 and UE 1004 via the CN 1024. The application server 1030 may communicate with the CN 1024 through an IP communications interface 1032.

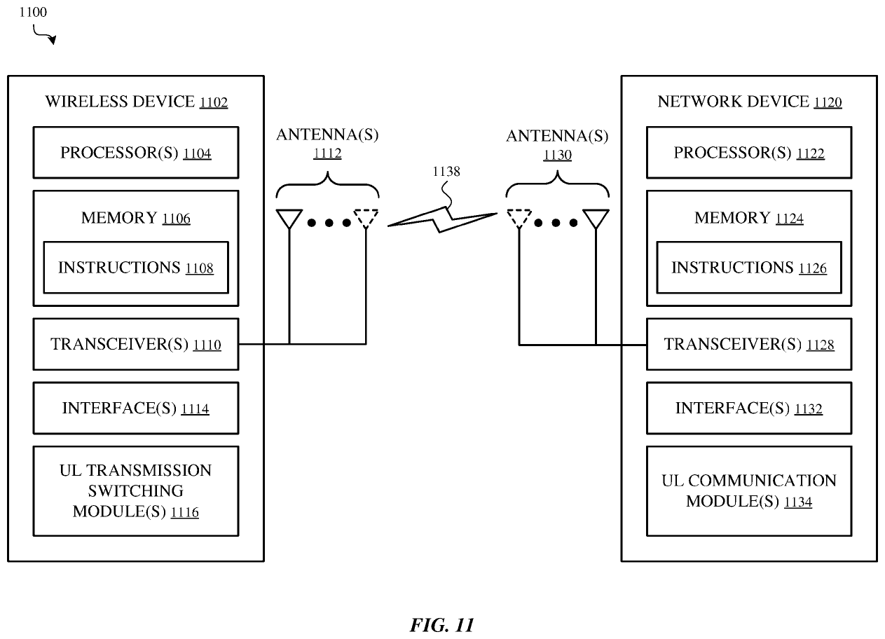

FIG. 11 illustrates a system 1100 for performing signaling 1138 between a wireless device 1102 and a network device 1120, according to embodiments disclosed herein. The system 1100 may be a portion of a wireless communications system as herein described. The wireless device 1102 may be, for example, a UE of a wireless communication system. The network device 1120 may be, for example, a network device (e.g., an eNB or a gNB) of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 that may include radio frequency (RF) transmitter and/or receiver circuitry that use the antenna(s) 1112 of the wireless device 1102 to facilitate signaling (e.g., the signaling 1138) to and/or from the wireless device 1102 with other devices (e.g., the network device 1120) according to corresponding RATs.

The wireless device 1102 may include one or more antenna(s) 1112 (e.g., one, two, four, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include an UL transmission switching module(s) 1116. The UL transmission switching module(s) 1116 may be implemented via hardware, software, or combinations thereof. For example, the UL transmission switching module(s) 1116 may be implemented as a processor, circuit, and/or instructions 1108 stored in the memory 1106 and executed by the processor(s) 1104. In some examples, the UL transmission switching module(s) 1116 may be integrated within the processor(s) 1104 and/or the transceiver(s) 1110. For example, the UL transmission switching module(s) 1116 may be implemented by a combination of software components (e.g., executed by a DSP or a general processor) and hardware components (e.g., logic gates and circuitry) within the processor(s) 1104 or the transceiver(s) 1110.

The UL transmission switching module(s) 1116 may be used for various aspects of the present disclosure, for example, aspects of FIG. 1 through FIG. 9. The UL transmission switching module(s) 1116 may be configured to, for example, apply or implement the techniques for UL switching with associated bands described herein.

The network device 1120 may include one or more processor(s) 1122. The processor(s) 1122 may execute instructions such that various operations of the network device 1120 are performed, as described herein. The processor(s) 1122 may include one or more baseband processors implemented using, for example, a CPU, a DSP, an ASIC, a controller, an FPGA device, another hardware device, a firmware device, or any combination thereof configured to perform the operations described herein.

The network device 1120 may include a memory 1124. The memory 1124 may be a non-transitory computer-readable storage medium that stores instructions 1126 (which may include, for example, the instructions being executed by the processor(s) 1122). The instructions 1126 may also be referred to as program code or a computer program. The memory 1124 may also store data used by, and results computed by, the processor(s) 1122.

The network device 1120 may include one or more transceiver(s) 1128 that may include RF transmitter and/or receiver circuitry that use the antenna(s) 1130 of the network device 1120 to facilitate signaling (e.g., the signaling 1138) to and/or from the network device 1120 with other devices (e.g., the wireless device 1102) according to corresponding RATs.

The network device 1120 may include one or more antenna(s) 1130 (e.g., one, two, four, or more). In embodiments having multiple antenna(s) 1130, the network device 1120 may perform MIMO, digital beamforming, analog beamforming, beam steering, etc., as has been described.

The network device 1120 may include one or more interface(s) 1132. The interface(s) 1132 may be used to provide input to or output from the network device 1120. For example, a network device 1120 that is a network device may include interface(s) 1132 made up of transmitters, receivers, and other circuitry (e.g., other than the transceiver(s) 1128 and antenna(s) 1130 already described) that enables the network device to communicate with other equipment in a core network, and/or that enables the network device to communicate with external networks, computers, databases, and the like for purposes of operations, administration, and maintenance of the network device or other equipment operably connected thereto.

The network device 1120 may include an UL communication module(s) 1134. The UL communication module(s) 1134 may be implemented via hardware, software, or combinations thereof. For example, the UL communication module(s) 1134 may be implemented as a processor, circuit, and/or instructions 1126 stored in the memory 1124 and executed by the processor(s) 1122. In some examples, the UL communication module(s) 1134 may be integrated within the processor(s) 1122 and/or the transceiver(s) 1128. For example, the UL communication module(s) 1134 may be implemented by a combination of software components (e.g., executed by a DSP or a general processor) and hardware components (e.g., logic gates and circuitry) within the processor(s) 1122 or the transceiver(s) 1128.

The UL communication module(s) 1134 may be used for various aspects of the present disclosure, for example, aspects of FIG. 1 through FIG. 9. The UL communication module(s) 1134 may be configured to, for example, apply or implement the network-related UL communication and signaling in accordance with the techniques for UL switching with associated bands described herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
one or more transceivers; and
a processor configured to,
receive, via the one or more transceivers, an uplink (UL) switching indication that indicates UL transmission switching on one antenna port;
receive, via the one or more transceivers, a first downlink control information (DCI) that triggers a first UL transmission switch from one of a first band or a second band to a third band, the first band configured on a first transmit chain and the second band configured on a second transmit chain; and
switch the first band configured on the first transmit chain to the third band based at least in part on an UL switching period determination or a network configuration indicating an UL switch from the first band configured on the first transmit chain.

2. The UE of claim 1, wherein the processor is further configured to:
refrain from UL transmission on the second band configured on the second transmit chain during an UL switching period for UL switching between the first band and the third band.

3. The UE of claim 1, wherein the processor is further configured to:
determine the UL switching period determination as a maximum of:
a first UL switching gap for UL switching between the first band and the third band; and
a second UL switching gap for UL switching between the second band and the third band; and
switch the first band configured on the first transmit chain to the third band based at least in part on the UL switching period determination that first UL switching gap is longer than the second UL switching gap.

4. The UE of claim 1, wherein the processor is further configured to:
determine the UL switching period determination as a minimum of:
a first UL switching gap for UL switching between the first band and the third band; and
a second UL switching gap for UL switching between the second band and the third band; and
switch the first band configured on the first transmit chain to the third band based at least in part on the UL switching period determination that first UL switching gap is shorter than the second UL switching gap.

5. The UE of claim 1, wherein the processor is further configured to:
receive, via the one or more transceivers, an associated band configuration corresponding to a plurality of UL bands, the plurality of UL bands corresponding to one or more UL band combinations exclusive of the first band, the second band, and the third band.

6. The UE of claim 1, wherein the processor is further configured to:
receive, via the one or more transceivers, an associated band configuration corresponding to a plurality of UL bands, the plurality of UL bands corresponding to one or more UL band combinations including a first band combination including at least one of the first band or the second band, and the plurality of UL bands absent an indication of the third band.

7. The UE of claim 1, wherein the processor is further configured to:
receive, via the one or more transceivers, an associated band configuration corresponding to a plurality of UL bands, the plurality of UL bands corresponding to a second UL band combination including the third band and absent an indication of an associated band for the third band.

8. The UE of claim 1, wherein the processor is further configured to:
receive the UL switching indication that indicates UL transmission switching on one antenna port via radio resource control (RRC) signaling.

9. A user equipment (UE), comprising:
one or more transceivers; and
a processor configured to,
transmit, via the one or more transceivers, a first UE capability, wherein the first UE capability indicates support to switch a transmit chain to an associated band;
receive, via the one or more transceivers, an associated band configuration based at least on a transmission of the first UE capability;
receive, via the one or more transceivers, an uplink (UL) switching indication that indicates UL transmission switching on one antenna port;
receive, via the one or more transceivers, a first downlink control information (DCI) that triggers a first UL transmission switch from one of a first band or a second band to a third band, the first band configured on a first transmit chain and the second band configured on a second transmit chain; and
switch the first band configured on the first transmit chain to the third band based at least in part on the first UE capability and associated band configuration.

10. The UE of claim 9, wherein the processor is further configured to:
determine that the associated band configuration includes a first band pair indication that the second band is for the third band; and
switch the first band configured on the first transmit chain to the third band based at least in part on a determination that the associated band configuration includes the first band pair indication.

11. The UE of claim 9, wherein the processor is further configured to:
determine that the associated band configuration includes a second band pair indication that a fourth band is for the third band; and
switch the second band configured on the second transmit chain to the fourth band based at least in part on a determination that the associated band configuration includes the second band pair indication.

12. The UE of claim 11, wherein the processor is further configured to:
determine that a first UL switching gap for UL switching between the first band and the third band is longer than or equal to a second UL switching gap for UL switching between the second band and the fourth band; and
switch the second band configured on the second transmit chain to the fourth band based at least in part on the determination that the associated band configuration includes the second band pair indication and a determination that the first UL switching gap is longer than or equal to the second UL switching gap.

13. The UE of claim 11, wherein the processor is further configured to:
determine that a first UL switching gap for UL switching between the first band and the third band is shorter than a second UL switching gap for UL switching between the second band and the fourth band; and
switch the second band configured on the second transmit chain to the third band based at least in part on the determination that the associated band configuration includes the second band pair indication and a determination that the first UL switching gap is shorter than the second UL switching gap.

14. The UE of claim 11, wherein the processor is further configured to:
determine that a first UL switching gap for UL switching between the first band and the third band is shorter than or equal to a second UL switching gap for UL switching between the second band and the fourth band; and
switch the second band configured on the second transmit chain to the fourth band based at least in part on the determination that the associated band configuration includes the second band pair indication and a determination that the first UL switching gap is shorter than or equal to the second UL switching gap.

15. The UE of claim 11, wherein the processor is further configured to:
determine that a first UL switching gap for UL switching between the first band and the third band is longer than a second UL switching gap for UL switching between the second band and the fourth band; and
switch the second band configured on the second transmit chain to the third band based at least in part on the determination that the associated band configuration includes the second band pair indication and a determination that the first UL switching gap is longer than the second UL switching gap.

16. The UE of claim 11, wherein the processor is further configured to:
determine a first UL switching period as a maximum of:
a first UL switching gap for UL switching between the first band and the third band;
a second UL switching gap for UL switching between the second band and the fourth band;
a third UL switching gap for UL switching between the second band and the third band; and
a fourth UL switching gap for UL switching between the first band and the fourth band; and
switch, during the first UL switching period, the first band configured on the first transmit chain to the third band and the second transmit chain to the fourth band based at least in part on the determination that the associated band configuration includes the second band pair indication.

17. The UE of claim 9, wherein the first UE capability is a per band combination capability and indicates support to switch a transmit chain to an associated band for a first band combination including the first band, the second band, and the third band.

18. A user equipment (UE), comprising:
one or more transceivers; and
a processor configured to,
transmit, via the one or more transceivers, a first UE capability, wherein the first UE capability indicates support to switch a transmit chain to an associated band;
transmit, via the one or more transceivers, a second UE capability, wherein the second UE capability indicates support to transmit on an unchanged transmit chain during an uplink (UL) switching period for a switching transmit chain;
receive, via the one or more transceivers, an associated band configuration based at least on a transmission of the first UE capability;
receive, via the one or more transceivers, an UL switching indication that indicates UL transmission switching on one antenna port;
receive, via the one or more transceivers, a first downlink control information (DCI) that triggers a first UL transmission switch from one of a first band or a second band to a third band, the first band configured on a first transmit chain and the second band configured on a second transmit chain;
switch, during a first UL switching period, the first band configured on the first transmit chain to the third band based at least in part on the associated band configuration; and

19. The UE of claim 18, wherein the processor is further configured to:
receive, via the one or more transceivers, a second DCI that triggers a second UL transmission on the second band at a second UL transmission starting time; and
transmit, via the one or more transceivers and during the first UL switching period, the second UL transmission on the second band configured on the second transmit chain based at least in part on the second UE capability.

20. The UE of claim 18, wherein:
the second UE capability is a per band combination capability and indicates support to transmit on an unchanged transmit chain for a first band combination including the first band, the second band, and the third band.
